(19) United States
(12) Patent Application Publication
(10) Pub. No.: US 2014/0306499 A1
(43) Pub. Date: Oct. 16, 2014

(54) VEHICLE SEAT COVER

(71) Applicant: Seat People LLC, Denver, CO (US)

(72) Inventors: Tyler Ross Wright, San Diego, CA (US); Rebecca Wright, San Diego, CA (US); Daniel Wright, Denver, CO (US)

(21) Appl. No.: 14/252,559

(22) Filed: Apr. 14, 2014

Related U.S. Application Data
(60) Provisional application No. 61/811,708, filed on Apr. 13, 2013.

(51) Int. Cl. B60N 2/60; G09F 21/04

(52) U.S. Cl. CPC B60N 2/60; B60N 2/6018; G09F 21/045
USPC 297/223

(57) ABSTRACT

Described herein is a vehicle seat cover. One vehicle seat cover comprises an upper section and a lower section. The upper section is adapted to couple to couple to a vehicle seat back and the lower section adapted to couple to a vehicle seat bench. At least one of the upper section and the lower section comprises a base section and a removable face section.

### PRIORITY

This application claims priority to U.S. Provisional Application No. 61/811,708, filed Apr. 13, 2013 and entitled Seat Cover with Removable Face, which is incorporated herein by reference.

### FIELD OF THE INVENTION

The present invention relates to a vehicle seat cover. In particular, but not by way of limitation, the present invention relates to a vehicle seat cover having an exchangeable seat face comprising an advertisement.

### BACKGROUND OF THE INVENTION

In a world covered by advertisements, functional and unique advertising space is at a premium. Advertisements can be found inside and outside of many modes of transportation, taxis, buses and airplanes. However, overlooked potential spaces for advertisements are the seats of these vehicles.

Before a passenger takes a seat in a vehicle, especially a vehicle that is frequently occupied such as, but not limited to, a taxi, bus or airplane, the passenger often looks intently at the seat to ensure it is free of hazards. For example, there is nothing worse than sitting in gum. As people train themselves to evaluate the seating of vehicles and seats in general, a seat is a perfect spot for an advertising display as the advertisement is sure to be seen by many people.

Current taxi cab advertisements located on the outside of the vehicle, or in various non-vehicle rear-seat surfaces may be updated every 6 to 10 weeks. However, some taxicab markets, such as, but not limited to, Las Vegas or New York, may use a shorter advertising cycle. Prior art seat covers are too expensive to cost-effectively create a new seat cover to meet these advertising cycles. Furthermore, the time it takes to produce a prior art seat cover may limit the ability to meet strict advertising cycle deadlines.

Another problem with replacing the entire seat cover for each advertisement is the time-of-installation of prior-art seat covers. The cost of the labor alone that is associated with replacing prior art seat covers creates a barrier for many advertisers wishing to use seat covers for advertising space. Furthermore, replacing such prior art seat covers takes a vehicle or other seat-providing area out of service and therefore results in lost revenue. For example, to install prior art covers properly, the seat often needs to be completely removed, then the new cover is attached and the seat is put back into the vehicle. Another issue is that prior art seat covers do not provide a comfortable seat surface while also ensuring that the seat cover does not move during use of the seat.

### SUMMARY OF THE INVENTION

The present invention solves each of these problems by allowing an advertisement or other display to be economically and efficiently placed on a seat, without substantially movement of the display while the seat is in use. One embodiment of the invention comprises a vehicle seat cover. The vehicle seat cover comprises an upper section and a lower section. The upper section may be adapted to couple to a vehicle seat back and the lower section may be adapted to couple to a vehicle seat bench. Furthermore, at least one of the upper section and the lower section may comprise a base section and a removable face section.

Another embodiment of the invention comprises a method of providing a display on a vehicle seat. One such method comprises coupling a seat cover base section to at least one of a vehicle seat back and a vehicle seat bench. The method may further comprise coupling at least one removable seat cover face section to the seat cover base section. The at least one removable face section may comprise a bottom surface and a top surface. The method may further comprise exposing the top surface to a user of the vehicle seat and viewing a display provided by the at least one removable seat cover face section.

Yet another embodiment of the invention comprises a seat. The seat comprises at least one of a seat back and a seat bench. The seat further comprises a cover at least substantially enclosing a portion of one of the seat back and seat bench. Furthermore, the cover comprises at least one first section coupled to at least one second section, with the second section coupled to at least one of the seat back and seat bench. The first section is further adapted to be removed from the second section without the second section being uncoupled from the at least one of the seat back and seat bench.

The above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 depicts an isometric view of a vehicle seat cover coupled to a vehicle seat according to one embodiment of the invention;

FIG. 2 depicts a vehicle seat cover lower section coupled to a vehicle seat bench according to one embodiment of the invention;

FIG. 3 depicts a vehicle seat cover upper section coupled to a vehicle seat back according to one embodiment of the invention;

FIG. 4 depicts a vehicle seat cover upper section partially coupled to a vehicle seat back according to one embodiment of the invention;

FIG. 5 depicts a vehicle seat cover lower section partially coupled to a vehicle seat bench according to one embodiment of the invention;

FIG. 6 depicts a vehicle seat cover upper removable face section according to one embodiment of the invention;

FIG. 7 depicts a vehicle seat cover upper section coupled to a vehicle seat back according to one embodiment of the invention;

FIG. 8 depicts a vehicle seat cover coupled to a vehicle seat with an upper removable face section partially coupled to the upper base section according to one embodiment of the invention;

FIG. 8-1 depicts a close-up of the fastening device according to one embodiment of the invention;

FIG. 9A depicts an upper base section coupled to a vehicle seat back according to one embodiment of the invention;

FIG. 9B depicts an upper base section coupled to a vehicle seat back and a removable face section partially coupled to the upper base section according to one embodiment of the invention; and

FIG. 10 depicts a method that may be carried with the embodiments discussed herein.

### DETAILED DESCRIPTION

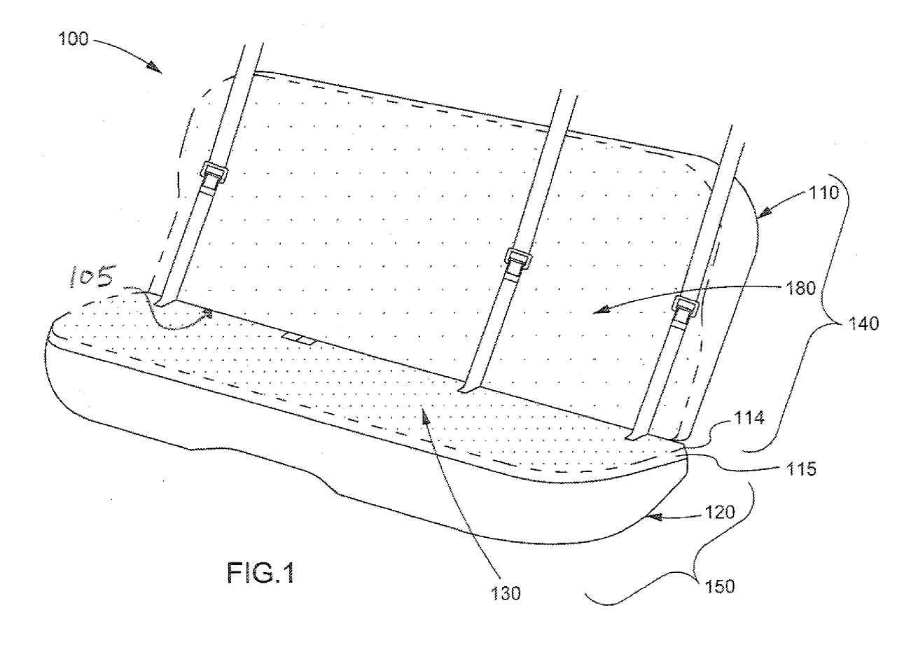

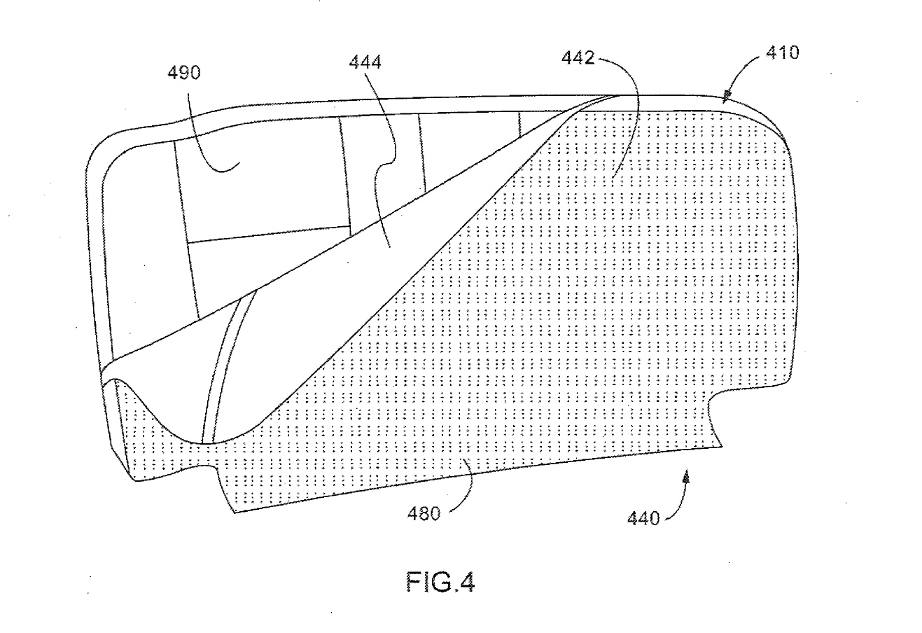

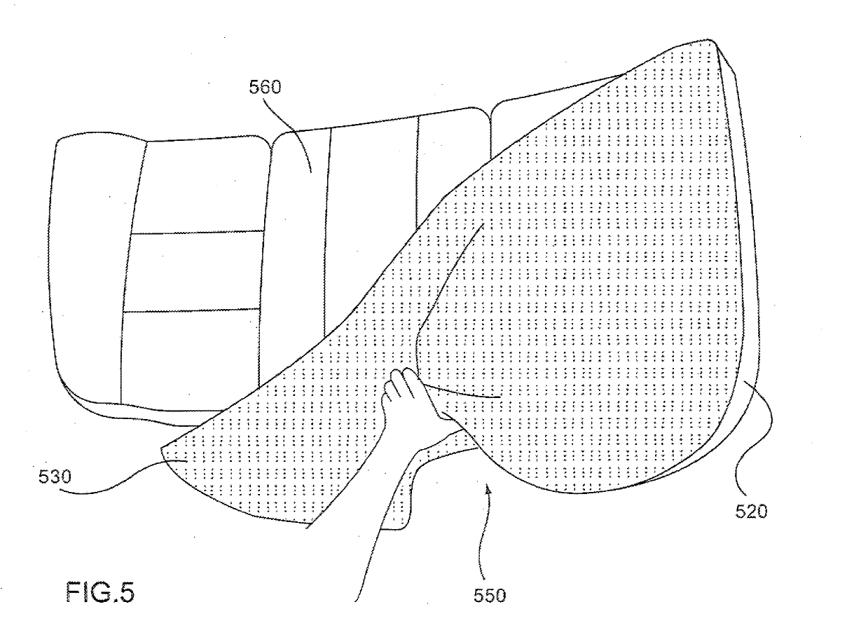

Turning first to FIG. 1, seen is a vehicle seat cover 100. One vehicle seat cover 100 comprises an upper section 140 adapted to couple to couple to a vehicle seat back and a lower section 150 adapted to couple to a vehicle seat bench. The term “bench” may refer to any type of seating surface—bucket seats, boating seats, airplane seats, etc. At least one of the upper section 140 and the lower section 150 comprises a base section, and a removable face section. For example, the upper section may comprise an upper base section 110 and upper removable face section 180 while the lower section 150 may comprise a lower base section 120 and lower removable face section 130. Seen in FIG. 4 is an upper removable face section 480 coupled to an upper base section 410, with the upper section 440 being placed (i.e., “coupled’) on a vehicle seat back 490. Similarly, seen in FIG. 5 is a lower base section 520 coupled to a lower removable face 530 being placed on a vehicle seat bench 560. Although FIGS. 4 and 5 show the upper section 440 is separate from the lower section 550, it is also contemplated that one or more portions of the upper section 440 may be at least one of coupled and integrated to one or more portions of the lower section 550. For example, the lower base section 520 may be coupled or integrated to the upper base section 410. It is also contemplated that the upper removable face 480 may be coupled or integrated to the lower removable face 530. Throughout the specification and claims, the term “coupled” refers to two or more separate and individual items joined together, often through a third or more additional items, where appropriate. Contrastingly, the term “integrated” may refer to two items which comprise a single unitary device by, for example, a portion of a material extending from a first of the two items to a second of the two items.

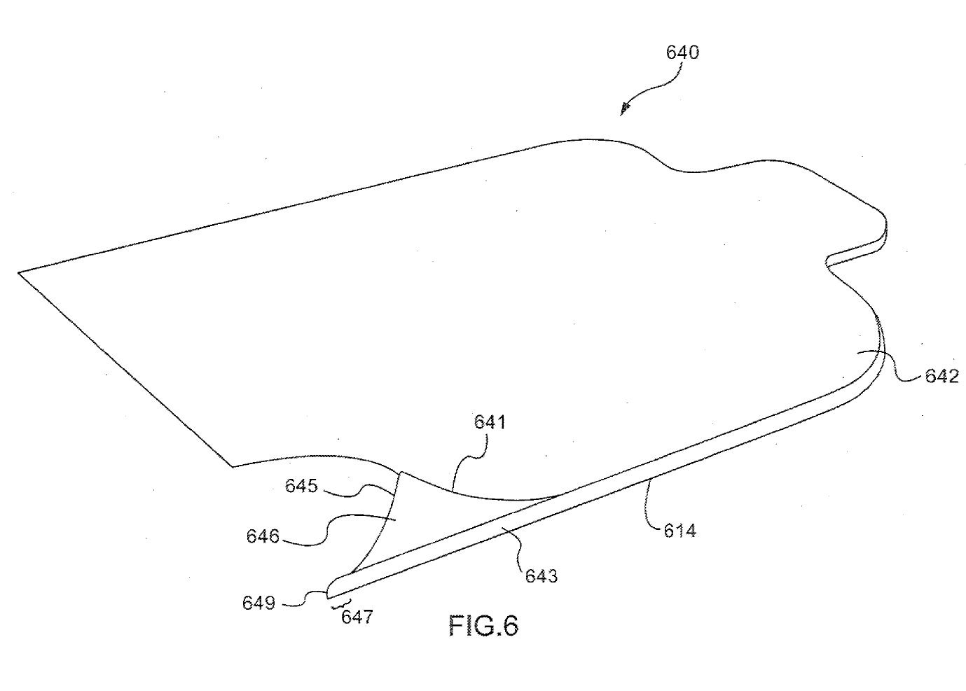

As seen in FIG. 4, the upper removable face 440 may comprise a front surface 442 and a back surface 444. The front surface 442 may display an advertisement. However, other non-advertising textual and/or graphical uses of the front surface 442 are also contemplated. In one embodiment, and as seen in FIGS. 4 & 6, the upper removable face 640 may comprises a first material comprising a back surface 444, a second material comprising the front surface 442 and a third material comprising one or more edge section 646. For example, the first material may comprise a flexible and polymeric and/or elastomeric material or composite adapted to return to its original shape after force is applied to the material. One such material may comprise a composite of lower density rubbery substances such as, but not limited to, open cell styrene, butadiene rubber or open cell styrene-butadiene (SBR). It is contemplated that whatever the material that is used for the bottom surface 444, friction may be created between the bottom surface 444 and a second surface adapted to contact the bottom surface 444 when the upper section 440 is in place. For example, as seen in FIG. 4, this second surface is an outer surface of the vehicle seat back 490. The front surface 442 may comprise a fabric which may be bonded (e.g., laminated) to an upper surface (not shown/identified) of the material comprising the bottom surface 444. Other non-fabric materials are also contemplated. It is this fabric or non-fabric material which may comprise the advertisement or other graphical display. The third material may comprise elastane (i.e., spandex) or any other elastomeric fiber such as, but not limited to, non-synthetic latex, or any other polymer or composite which may comprise a polyurethane-polyurea copolymer. The third material may be placed in one or more sections of the removable face 640 comprising high-stress sections where a higher degree of elastic properties in a material is needed to prevent tearing and/or other irreversible deformation (e.g. plastic) of the material. A material first edge 641 of the third material may be coupled to the second and/or third material. (front surface 642 and/or bottom surface 444), a second edge 643 may couple to a fastening device 614 and a third edge 645 may not couple to any other material or device. It is contemplated that a fastening device section 647 may extend beyond the third edge 645 to enable a person to locate an end of the fastening device 614 when installing or removing the face 640. The section 647 may be 10-20 times longer than the section 647 seen in FIG. 6. It is also contemplated that the term fastening device may be referred to herein as attachment mechanism or attachment device.

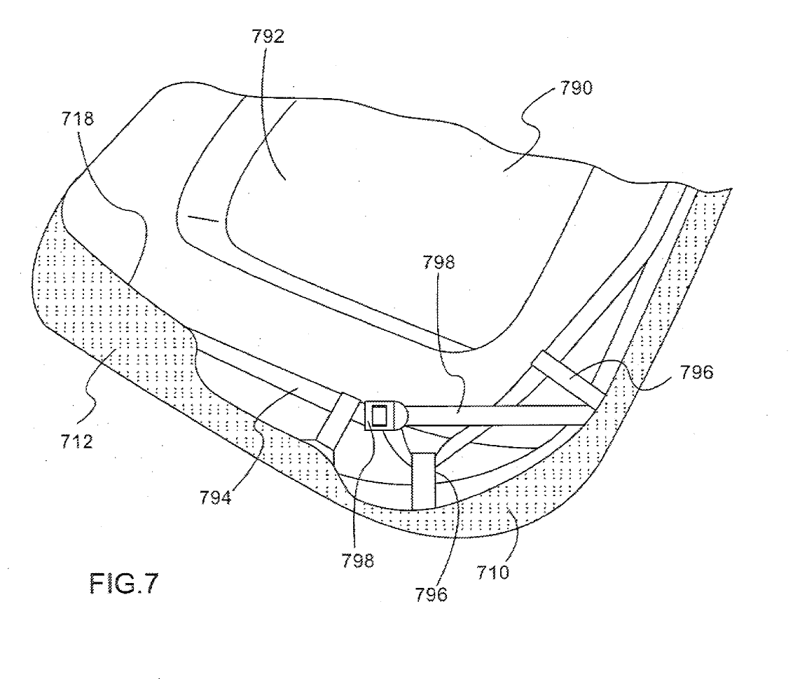

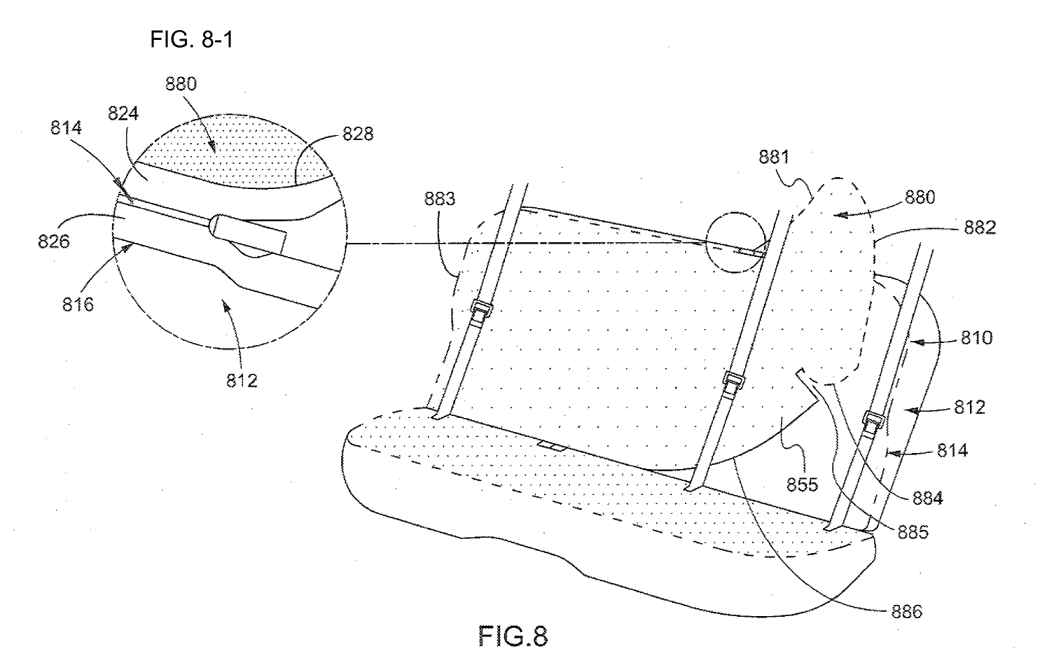

Turning now to FIG. 7, seen is a view of the upper base section 710 coupled to a vehicle seat back 790. Although a back surface 792 of the vehicle seat back 790 is seen in FIG. 7, the upper base section 710 may couple to other surfaces (e.g., front, side, etc.) of the vehicle seat back 790. As seen, the upper base section 710 may comprise one or more upper base section side walls 712. The upper base section 710 may comprise a fabric such as a woven synthetic fabric, or may comprise any other natural fabric, polymeric, and/or elastomeric material. As seen together with FIGS. 8 & 8-1, a first edge 816 of the one or more upper base section side walls 812 may be coupled to a fastening device 814 adapted to couple the upper base section 810 to the upper removable face section 880. For example, the upper removable face section may comprise an outer removable face section edge 828. One fastening device 814 may comprise a zipper. However, the fastening device 814 may also comprise hook-loop material or may comprise snaps, buttons, one or more clasping mechanism, or any other fastening device 814 known in the art. The side walls 812 may extend away from the fastening device 812, as seen in FIG. 8, ending in a second edge 718, as seen in FIG. 7. An elastomeric material may be sewn or otherwise coupled to the side walls 712 proximal the second edge 718. The elastomeric material may be adapted to keep the side walls 712 against and coupled to the vehicle seat back 790. Additionally, one or more strapping sections 794 may be coupled to the side walls 712. Such coupling may occur through sewing or any other coupling method or device known in the art. The strapping sections 794 may comprise nylon strapping. However, other materials are also contemplated. The strapping sections 794 may be placed through, or may be coupled, to one or more strapping loops 796 and may comprise a tightening mechanism 798 which may comprise a buckle and a strap extension. The strapping sections 794 and loops 796 may be coupled to a plurality of locations on the side walls 712.

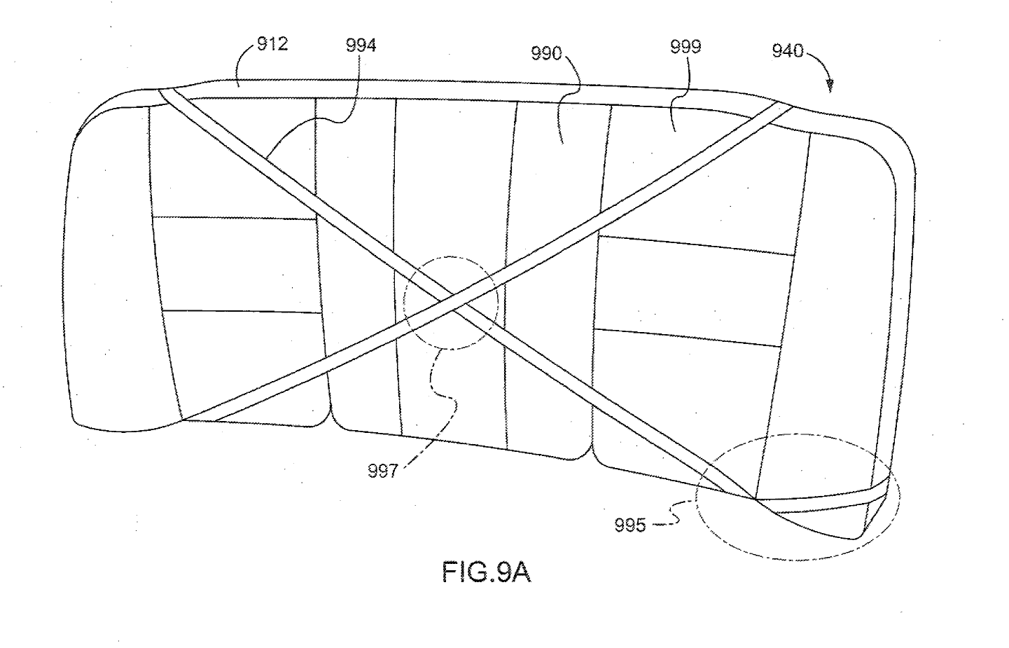

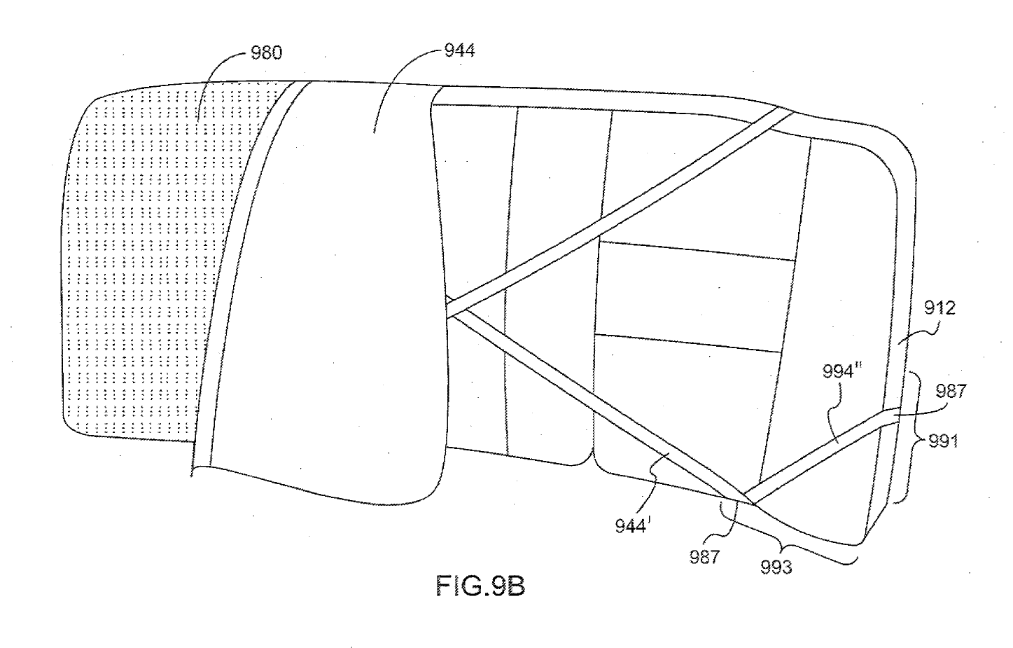

In looking now at FIG. 9A, seen is the vehicle seat back 990 with the removable face 640 seen in FIG. 6 uncoupled from the base 912. As seen, strapping sections 994 also extend across a front surface 999 of the vehicle seat back 990. In FIG. 9A the strapping sections 994 extend from proximal the four corners of the vehicle seat back 990 to an opposing corner in an “X” configuration. However, other configurations are contemplated. It is contemplated that the center portion 997 of the “X” may comprise an elastomeric material instead of the nylon or other fabric or polymeric material comprising the remaining portion of the strapping section 994. The elastomeric material in the center portion 997 may be coupled to the strapping sections 994 by sewing the elastomeric material to the strapping sections 994. One type of elastomeric material may comprise a polyurethane-polyurea copolymer or any other elastic material. Additionally, the strapping sections 994 may comprise at least one corner portion 995. As seen in FIG. 9B, a first strapping section 994′ may extend away from the center portion 997 towards a first side 993 of the at least one corner portion 995. A second strapping section 994″ may extend away from the first strapping section 994′ towards a second side 991 of the at least one corner portion 995. The second strapping section 994″ may extend generally perpendicularly away from the first strapping section. However, other angles are also contemplated. Ends 987 of the first strapping section 994′ and second strapping section 994″ may couple to the upper base section 912. It is contemplated that one or more of the strapping sections 994 seen in FIG. 9B may be one of coupled and integrated to one or more of the strapping sections 794 seen in FIG. 7.

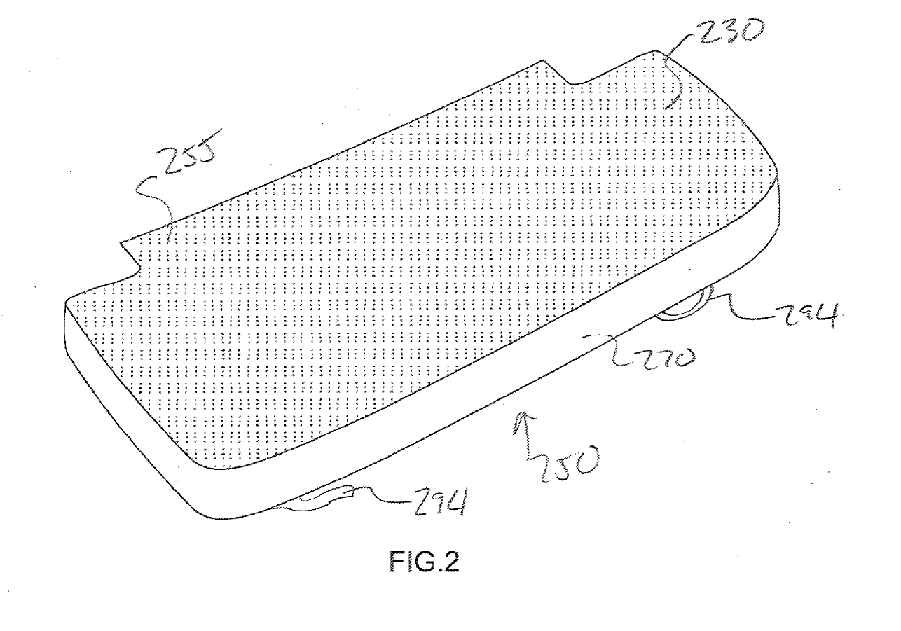

Returning now to FIG. 1, it is contemplated that the lower section 150 may be comprised substantially similarly as the upper section 140, although the lower section 150 may comprise different dimensions than the upper section 140 in order for the lower section to appropriately fit onto the bench 560 and the upper section to fit onto the back 490. Therefore, the references to the upper section 140 throughout the specification may also be applied to the lower section 150 and vice versa. For example, the description of the upper base section 110 and upper removable face section 180 may also apply to the lower base section 120 and lower removable face section 130. Similarly, and as seen in FIG. 2, the lower section 250 may comprise one or more strapping sections 294, which may operate similarly to the one or more strapping section 994 coupled to the upper section 940 seen in FIGS. 9A and 9B. Any other portion of the upper section 140 and described in reference to FIGS. 1-9B may also be applied to the lower section 250 and vice versa.

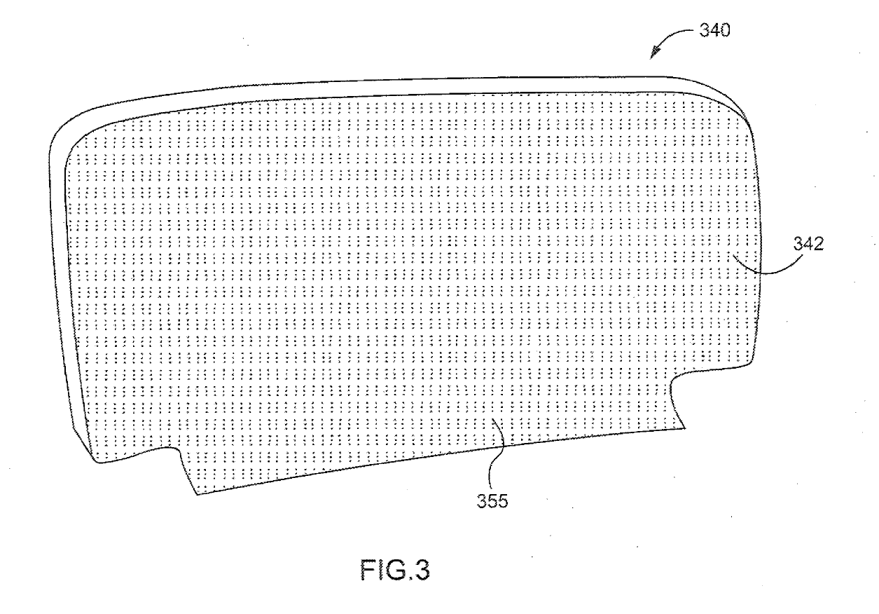

In looking at FIG. 2, seen is a lower section flap 255. The lower section flap 155 may comprise a portion of the lower removable face 230 and/or a portion of lower base section 220. Upon installation of the lower section 250, the lower section flap 155 may be adapted for placement in the seat crease 105 between the vehicle seat back 490, as seen in FIG. 4 and vehicle seat bench 560, as seen in FIG. 5. Such placement may help to decrease movement of the lower section 250. As seen in FIG. 3, the upper section 340 may comprise an upper section flap 355, which may operate similarly to the lower section flap 255.

In returning to FIGS. 8 & 8-1, it is contemplated that a fastening device first section 826 may be one of coupled and integrated to the upper base section 810 and a fastening device second section 824 may be one of coupled and integrated to the upper removable face section 880. The first section 826 may be adapted to couple to the second section 824. For example, the fastening device 814 may comprise a zipper. Furthermore, the fastening device 814 may be one of coupled and integrated to at least a portion of a removable face first edge 881, second edge 882 and third edge 883, with the first edge 881 comprising a top edge and the second and third edges 882, 883 comprising side edges of the face 880 in one embodiment, respectively. The fastening device 814 may also be located on at least a portion of a fourth edge 884, wherein the fastening device 814 may couple to the fourth edge 884 at a fourth edge location extending between a side edge 882, 883 and the flap 885. However, a flap edge 886 may also comprise a portion of the fastening device 814. The removable face 880 and/or base 810 may further comprise one or more notches 885 placed in the removable face 880 and/or base 810 which are adapted to receive a seatbelt or other restraining mechanism.

In looking at FIG. 1, the upper base section 110, lower base section 120, upper removable face section 180 and/or the lower removable fact section 130 may also comprise one or more additional sections 115. The one or more additional sections 115 may comprise material adapted to cover the fastening device 114 upon installation of the cover 100, in order to ensure the fastening device 114 does not come into contact (intentional or unintentional) with a person sitting on the vehicle seat. It is contemplated that although much of the application described herein applies to “vehicle seats,” the descriptions herein may also apply to non-vehicle seats, where appropriate.

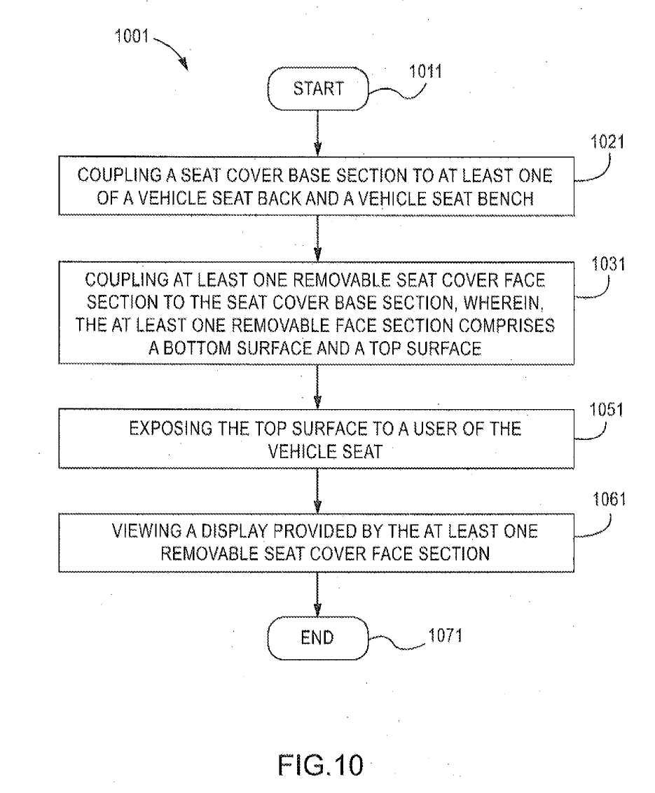

Turning now to FIG. 10, seen is a method 1001 providing a display on a vehicle seat such as, but not limited to the seat back 490 and bench 560 seen in FIGS. 4 and 5, respectively. The method 1001 starts at 1011 and at 1021 comprises coupling a seat cover base section to at least one of the vehicle seat back 490 and vehicle seat bench 560. As described above, coupling a seat cover base section such as, but not limited to, the upper base section 110 and/or the lower base section 120 seen in FIG. 1 to at least one of the vehicle seat back 490 and a vehicle seat bench 560 seen in FIGS. 4 and 5, respectively, may comprise extending one or more first strapping sections 794, as seen in FIG. 7, around at least a portion of the vehicle seat back 790 and vehicle seat bench 560. Step 1021 may further comprise extending the one or more second strapping sections between at least two base section locations, with the one or more second strapping sections being located proximal a removable face bottom surface. For example, the strapping sections 994 seen in FIG. 9A may comprise one or more second strapping sections and may couple to the base section 912 at at least two base section locations. Furthermore, and as seen in FIG. 9B, upon installation of the removable face 980, a removable face back surface 944 may be located proximal the strapping section 994.

Moving on now to step 1031, seen is a step of coupling at least one removable seat cover face section, such as, but not limited to, the upper removable face section 180 or lower removable face section 130, respectively, to a seat cover base section, such as, but not limited to, the upper base section 110 or lower base section 120, respectively. It is contemplated that the at least one removable face section comprises a bottom surface such as, but not limited to, the back surface 944 seen in FIG. 9 and a top surface, such as, but not limited to, the front surface 442 seen in FIG. 4. At step 1051, the method 1001 comprises exposing the top surface to a user of the vehicle seat. For example, upon entering a vehicle, a person about to sit on the seat may see the display as seen on the front surface 242, 342 seen in FIGS. 2 & 3, respectively. Finally, at step 1061, the method 1001 may comprise viewing a display provided by the at least one removable seat cover face section.

Although not seen in FIG. 10, the method 1001 may further comprise sitting on the vehicle seat and preventing substantial movement of the vehicle seat cover 100 by using friction between the bottom surface and at least one of the vehicle seat back 490 and vehicle seat bench 560. For example, and as described above, due to the nature of the material on the bottom surface 444, friction may be created between the bottom surface 444 and the seat back 490 when the upper section 440 is in place. Similar friction may occur between the lower removable face 130 and the bench 560. Additional methods may also comprise using one or more loops 796 and connections such as, but not limited to, the tightening mechanism 798 which may comprise a buckle and a strap extension, to couple the seat cover base section 710 to at least one of the vehicle seat back 490 and a vehicle seat bench 560. It is contemplated that coupling at least one removable seat cover face section to the seat cover base section may comprise coupling an edge of the at least one removable seat cover face section to the seat cover base section. Additionally, methods 1001 may comprise removing the at least one removable seat cover face section to the seat cover base section, wherein, the at least one removable seat cover face section comprises a first at least one removable seat cover face section and coupling a second at least one removable seat cover face section to the seat cover base section.

Although the description herein incorporates describing the seat cover 100 see in FIG. 1, one embodiment of the invention further comprises a seat such as, but not limited to, a vehicle seat. One such vehicle seat comprises a seat back and a seat bench, such as the seat back 490 seen in FIG. 4 and the seat bench 560 see in FIG. 5. The seat may further comprise a cover such as, but not limited to, the cover 100 seen in FIG. 1. One such cover may substantially enclose a portion of the back 490 and bench 560. Furthermore, the cover may comprise at least one first section coupled to at least one second section. The first section may comprise the removable face sections 180, 130 seen in FIG. 1 while the second section may comprise the upper and lower base sections 110, 120 seen in FIG. 1. In one such embodiment, the second section may be coupled to at least one of the seat back and the seat bench while the first section is adapted to be removed from the second section without the second section being uncoupled from the seat back and seat bench.

The seat of claim 16 further comprising, a plurality of strapping, the plurality of strapping at least one of coupled and integrated to the second section; and a fastener, the fastener adapted to couple the at least one first section to the at least one second section. The seat of claim 17 wherein, at least a portion of the strapping comprises an elastomeric material. The seat of claim 16 wherein, the seat comprises a vehicle seat. The seat of claim 16 wherein, the first section comprises a display.

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A vehicle seat cover comprising,
an upper section adapted to couple to couple to a vehicle seat back;
a lower section adapted to couple to a vehicle seat bench; and
wherein, at least one of the upper section and the lower section comprises,
a base section, and
a removable face section.

2. The vehicle seat cover of claim 1 wherein,
the upper section comprises an upper base section;
the lower section comprises a lower base section; and
the upper base section is one of coupled and integrated to the lower base section.

3. The vehicle seat cover of claim 1 wherein, the removable face section comprises an advertisement.

4. The vehicle seat cover of claim 3 wherein,
the base section is coupled to at least one of the vehicle seat back and vehicle seat bench;
the removable face section is coupled to the base section; and
the advertisement is displayable to a person viewing the removable face section.

5. The vehicle seat cover of claim 1 further comprising at least one fastening device, wherein the at least one fastening device is adapted to couple the removable face section to the base section.

6. The vehicle seat cover of claim 5 wherein,
the base section comprises one or more side walls;
the one or more side walls comprise a first edge;
the removable face section comprises an outer removable face section edge; and
the at least one fastening device is adapted to couple the first edge to the outer removable face section edge.

7. The vehicle seat cover of claim 6 further comprising, one or more additional material sections, the one or more additional material sections adapted to substantially cover the at least one fastening device when the first edge is coupled to the outer removable face section edge.

8. The vehicle seat cover of claim 1 further comprising,
one or more attachment devices, the one or more attachment devices adapted to couple the vehicle seat cover to the vehicle seat bench and vehicle seat back.

9. The vehicle seat cover of claim 8, wherein,
the one more attachment devices comprise a plurality of strapping;
the base section comprises one or more walls;
at least a first portion of the plurality of strapping is,
coupled to the one or more walls, and
is adapted to couple to at least one vehicle seat corner; and
at least a second portion of the plurality of strapping extends across a front surface of the vehicle seat.

10. A method of providing a display on a vehicle seat comprising,
coupling a seat cover base section to at least one of a,
vehicle seat back, and
vehicle seat bench;
coupling at least one removable seat cover face section to the seat cover base section, wherein, the at least one removable face section comprises a bottom surface and a top surface;
exposing the top surface to a user of the vehicle seat; and
viewing a display provided by the at least one removable seat cover face section.

11. The method of claim 10 wherein,
the removable face section comprises a bottom surface; and
coupling a seat cover base section to at least one of a vehicle seat back and a vehicle seat bench comprises,
extending one or more first strapping sections around at least a portion of the,
vehicle seat back, and
vehicle seat bench; and
extending the one or more second strapping sections between at least two base section locations, wherein the one or more second strapping sections are located proximal the bottom surface.

12. The method of claim 11 further comprising,
sitting on the vehicle seat; and
preventing substantial movement of the vehicle seat cover by using friction between the bottom surface and at least one of the,
vehicle seat back, and
vehicle seat bench.

13. The method of claim 11 further comprising, using one or more loops and connections to couple the seat cover base section to at least one of a vehicle seat back and a vehicle seat bench.

14. The method of claim 10, wherein, coupling at least one removable seat cover face section to the seat cover base section comprises coupling an edge of the at least one removable seat cover face section to the seat cover base section.

15. The method of claim 10, further comprising,
removing the at least one removable seat cover face section to the seat cover base section, wherein, the at least one removable seat cover face section comprises a first at least one removable seat cover face section; and
coupling a second at least one removable seat cover face section to the seat cover base section.

16. A seat comprising,
at least one of a seat,
back, and
bench;
a cover at least substantially enclosing a portion of the,
back, and
bench; and
wherein,
the cover comprises at least one first section coupled to at least one second section,
the second section is coupled to at least one of the seat,
back, and
bench, and
the first section is adapted to be removed from the second section without the second section being uncoupled from the at least one of the seat,
back, and
bench.

17. The seat of claim 16 further comprising,
a plurality of strapping, the plurality of strapping at least one of coupled and integrated to the second section; and
a fastener, the fastener adapted to couple the at least one first section to the at least one second section.

18. The seat of claim 17 wherein, at least a portion of the strapping comprises an elastomeric material.

19. The seat of claim 16 wherein, the seat comprises a vehicle seat.

20. The seat of claim 16 wherein, the first section comprises a display.
